(19) United States
(12) Patent Application Publication
(10) Pub. No.: US 2008/0151238 A1
(43) Pub. Date: Jun. 26, 2008

(54) Simultaneous Spatial and Temporal Focusing of Femtosecond Pulses

(75) Inventors: Guanghao Zhu, Ithaca, NY (US); Chris Xu, Ithaca, NY (US)

Correspondence Address: NIXON PEABODY LLP - PATENT GROUP, 1100 CLINTON SQUARE, ROCHESTER, NY, 14604, US

(73) Assignee: Cornell Research Foundation, Inc., Ithaca, NY (US)

(21) Appl. No.: 11/817,768

(22) PCT Filed: Mar. 1, 2006
(86) PCT No.: PCT/US06/07088

§ 371 Date: Oct. 26, 2007

Related U.S. Application Data
(60) Provisional application No. 60/656,901, filed on Mar. 1, 2005.

(51) Int. Cl. G01N 21/64

(52) U.S. Cl. 356/317

(57) ABSTRACT

A technique for simultaneous spatial and temporal focusing of femtosecond pulses improves the signal-to-back-ground ratio (SBR) in multiphoton imaging. This is achieved by spatially separating spectral components of pulses into a “rainbow beam” and recombining these components at the spatial focus of an imaging system. The temporal pulse width becomes a function of distance, with the shortest pulse width confined to the spatial focus. The technique can significantly improve the axial confinement and reduce the background excitation in multiphoton microscopy, and thereby increase the imaging depth in highly scattering biological specimens.

### BACKGROUND OF THE INVENTION

1. Field of the Invention

The present invention relates in general to a method and apparatus for simultaneous spatial and temporal focusing of femtosecond pulses to improve the axial confinement and thus signal-to-background ratio (SBR) in multiphoton imaging techniques, such as microspcopy, endoscopy, spectroscopy, fluorescence microscopy, second harmonic microscopy, etc. This is achieved by spatially separating spectral components of pulses and recombining these components only at the spatial focus of an imaging system. Thus, the temporal pulse width becomes a function of distance, with the shortest pulse width confined to the spatial focus.

2. Description of the Background Art

Laser scanning multiphoton microscopy (MPM) has greatly improved the penetration depth of optical imaging and proven to be well suited for a variety of imaging applications deep within intact or semi-intact tissues, such as demonstrated in the studies of neuronal activity and anatomy, developing embryos and tissue morphology and pathology. When compared to one-photon confocal microscopy, a factor of 2 to 3 improvement in penetration depth is attainable in MPM. Nonetheless, MPM has so far been restricted to less than 1 mm in depth in brain tissues, even with the heroic effort of employing energetic pulses (˜μJ/pulse) produced by a regenerative amplifier.

The intrinsic difficulty of imaging deep into biological tissues is scattering. In the context of multiphoton excitation, the effect of scattering is the reduction of the “imaging” photons (photons that maintain their ballistic trajectories) arriving at the focal volume. The excitation power (P) as a function of the penetration depth (z) obeys the well-known exponential behavior: P(z)=P(0)·exp(−z/lₛ), where lₛ is the scattering length of the sample. A constant signal level can obviously be maintained if one compensates the loss of excitation power at the focus by exponentially increasing the excitation power at the sample surface, i.e., by exponentially increasing P(0). However, as the penetration depth increases, the background, which includes all fluorescence that originates outside the focal volume and therefore carries no image information, eventually dominates the detected fluorescence. A mathematical analysis shows that the signal-to-background ratio (SBR) in two-photon excitation exponentially decays as a function of imaging depth and thus decreases to zero at large imaging depth. On the other hand, a minimum SBR is required for a satisfactory imaging performance. Thus, it is the SBR rather than the decreasing signal strength that intrinsically limits the maximum penetration depth in MPM. It is therefore evident that to increase penetration depth, a technique needs to be devised for increasing the SBR.

### SUMMARY OF THE INVENTION

The present invention fulfills the foregoing need through provision of a technique for simultaneous spatial and temporal focusing of femtosecond pulses in multiphoton imaging. This concept is realized by spatially separating spectral components of optical radiation pulses into a “rainbow beam” comprised of a plurality of spaced, preferably parallel beams of different wavelengths and recombining these components only at the spatial focus of an imaging system. As a result of this arrangement, the temporal pulse width becomes a function of distance, with the shortest pulse width being confined to the spatial focus. This will improve the SBR by reducing the background excitation while maintaining the signal strength. This is because the efficiency of multiphoton excitation, which is a nonlinear process, depends strongly on the excitation pulse width (τ) . For example, the excitation efficiency varies as τ⁻¹ for two-photon excited fluorescence. Thus, in addition to the spatial focusing, an extra degree of confinement for the excitation can be achieved if one can create a temporal focus where the pulse width varies along the propagation direction and the shortest pulse is only achieved at the focal point.

In the preferred embodiment, a chirp-free input rainbow beam is generated by first divergently separating the different spectral components from a mode-locked Ti:Sapphire laser using a reflective grating and then recollimating them using a cylindrical lens. The geometric dispersion caused by the grating is automatically canceled after the process of recollimation and therefore the rainbow spectrum after the cylindrical lens is chirp-free. The simultaneous temporal and spatial focusing effect is then realized by passing the rainbow beam through an objective lens, which focuses the beams both temporally and spatially at a focal point.

To intuitively understand why an extra degree of temporal focusing can be achieved with the invention, one should first consider how short pulses are generated in ultrafast optics. It is well known that in order to generate the shortest pulses at one particular spatial point, two critical conditions must be satisfied. The first condition requires that all the available spectral components must be completely spatially overlapped. The second condition requires that the entire optical spectrum must be chirp-free. Regarding the first condition, in the arrangement of the present invention, it can be seen that the best spatial overlap occurs only at the focal point. Regarding the second condition, if a chirp-free spectrum of the rainbow beam can be produced at the back aperture of the objective lens, then from the optical path argument, the required chirp-free condition can be re-achieved after the objective but only at the focal point. Since the realization of the above two conditions is restricted at the focal volume, it then follows that the temporal focusing effect will occur only at the vicinity of the focal point.

The present invention can also be employed to provide remote axial scanning of the maximum signal excitation plane for wide-field nonlinear microscopy, which is a practical concern in the design of a nonlinear microscopy system. The simultaneous spatial and temporal focusing technique of the present invention, when operated in the wide-field mode, provides a way to perform the axial scanning of the maximum signal excitation plane in the axial direction. Wide-field operation removes the spatial focusing and therefore inside the focal volume illumination field is only temporally focused. This temporal focusing is achieved because different colors are spatially separated, i.e. the effect of geometrical dispersion. By adjusting the input spectrum chirp using a grating pair or prism pair, the axial position of the maximum signal excitation plane shifts to the position where the input spectrum chirp is canceled by the geometrical dispersion, i.e. the position where the pulse temporal width is shortest.

Another application of the present invention is for automatic dispersion compensation in wide-field nonlinear microscopy based on a single-core fiber. Since short pulses are required at the sample end, due to the existence of relatively large fiber dispersion, regular methods typically require pre-dispersion compensation to prevent pulse broadening. However, when operating the simultaneous spatial and temporal focusing technique of the present invention in the wide-field mode, the fiber-delivery of ultrashort pulses is immune to the fiber chromatic dispersion. This is true because the simultaneous spatial and temporal focusing technique intrinsically inherits the geometrical dispersion into the system as a result of wavelength spatial separation. The dispersion accumulated through the propagation inside the fiber will be automatically compensated by shifting the temporal focal plane away from the geometrical optics one.

### BRIEF DESCRIPTION OF THE DRAWINGS

The various features and advantages of the invention will become apparent to those of skill in the art from the following description, taken with the accompanying drawings, in which:

FIG. 1 is a schematic illustration showing the concept of simultaneous temporal and spatial focusing of femtosecond pulses in accordance with the concept of the present invention;

FIG. 2 is a schematic illustration of an multiphoton imaging system that can be employed to implement the concept of the present invention (in the line-scanning mode) in accordance with a preferred embodiment thereof;

FIG. 3 are graphs showing auto-correlation traces of the measured pulse at different sample positions for an experiment conducted using the system of FIG. 2, with FIG. 3(a) showing the trace at the focal plane of the objective and FIG. 3(b) showing the trace at a point 275 μm away from focal plane. The inset inside trace (a) shows the interference fringes at the vicinity of zero time delay;

FIG. 4 is a graph illustrating the measured (solid square) and theoretically calculated (line) pulse width as a function of sample position for the experiments conducted with the system of FIG. 2, where the location of the focal plane of the objective lens is set to be zero;

FIG. 5 is a schematic illustration of an optical system using the concept of the present invention that can be employed to provide remote axial scanning of the maximum signal excitation plane for wide-field nonlinear microscopy; and

FIG. 6 is a schematic illustration of an optical system using the concept of the present invention that can be employed for automatic dispersion compensation in wide-field nonlinear microscopy based on a single-core fiber.

### DETAILED DESCRIPTION OF THE INVENTION

Turning now to a more detailed consideration of the subject invention, a discussion of the mathematical analysis of two photon excitation which led to the development of the present invention will first be presented. By assuming a uniform fluorophore distribution and taking into account that the beam cross section at the surface varies as ˜², a mathematical analysis shows that the signal-to-background ratio (SBR) in two-photon excitation is approximately given by:

$$SBR = \frac{2 {{π}^{2} ( NA )}^{2}}{n} \frac{{2}^{}}{λ {l}_{s}} exp ( - 2 / {l}_{s} ) , \qquad ( 1 )$$

where λ is the excitation wavelength, n is the refractive index of the medium, and NA is the numerical aperture of the objective lens. It should be noted that the derivation of Eq. (1) only takes into account the spatial focus and assumes that the temporal pulse width is independent of space, i.e., the excitation beam can be separated into independent spatial and temporal components. Being a nonlinear process, however, the efficiency of multiphoton excitation depends strongly on the excitation pulse width (τ) . For example, the excitation efficiency varies as τ⁻¹ for two-photon excited fluorescence. Thus, in addition to the spatial focusing, an extra degree of confinement for the excitation can be achieved if a temporal focus can be created where the pulse width varies along the propagation direction and the shortest pulse is only achieved at the focal point. Such a technique will improve the SBR by reducing the background excitation while maintaining the signal strength.

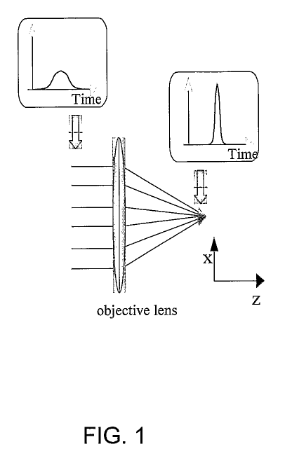

The basic principle for the simultaneous temporal and spatial focusing is illustrated in FIG. 1. Spatial focusing is still achieved by passing the light through an objective lens. However, instead of keeping all the spectral components well overlapped in space during the focusing process, they are first separated spatially and are then recombined only at the focal point. More particularly, the system input is a rainbow-like superposition of many parallel optical beams of which the center positions are linearly displaced according to their wavelengths. The spectrum of the input is assumed to be chirp-free. After passing through a regular objective lens, the rainbow beam is then focused and recombined in space. Temporal focusing is achieved because of the reduced spatial overlapping and the non-zero geometric dispersion outside the focal volume.

To intuitively understand why an extra degree of temporal focusing can be achieved in this manner, consider how short pulses are generated in ultrafast optics. It is well known that in order to generate the shortest pulses at one particular spatial point, two critical conditions must be satisfied. The first condition requires that all the available spectral components must be completely spatially overlapped. The second condition requires that the entire optical spectrum must be chirp-free. Regarding the first condition, in the present invention it can be seen that the best spatial overlap occurs only at the focal point. Regarding the second condition, if a chirp-free spectrum of the rainbow beam can be produced at the back aperture of the objective lens, then from the optical path argument, the required chirp-free condition can be re-achieved after the objective but only at the focal point. Since the realization of the above two conditions is restricted at the focal volume, it then follows that the temporal focusing effect will occur only at the vicinity of the focal point.

An analytical model for the temporal focusing was developed to supplement the intuitive picture described above. The theoretical analysis that follows is based on the Gaussian beam approximation under the paraxial limit. The steps of the calculation are as follows: first assume that the input beam profile at the back aperture of the objective can be written as a superposition of many monochromatic, spatially transform-limited Gaussian beams, of which the center positions are linearly displaced according to their wavelengths. It is further assumed that the optical spectrum of the input waveform at the back aperture of the objective is chirp-free and has a Gaussian spectral profile. Then, for each monochromatic Gaussian beam, calculate the evolution of the spatial beam profile analytically using the standard paraxial propagation method. Finally, evaluate the performance of the simultaneous temporal and spatial focusing by summing up all the monochromatic contributions. It should be noted that from FIG. 1, since the spatial coupling only happens between x and z directions, the dependence of the beam profile on the variable y is therefore dropped in the analysis.

Following the steps outlined above, the input beam amplitude A₁(x,t) is first written at the back aperture of the objective lens as a superposition of many spatial Gaussian beams, of which the center positions are linearly displaced according to their wavelengths,

$${A}_{1} ( x , t ) = {\int }_{- ∞}^{+ ∞} exp [ - \frac{{( x - α \cdot Δ ω )}^{2}}{{s}^{2}} ] \cdot exp [ - \frac{{Δω}^{2}}{{Ω}^{2}} + iΔω t ] \cdot d Δω , \qquad ( 2 )$$

where Δω is the offset frequency from the center of the input spectrum, \sqrt{2 ln 2}·Ω is the FWHM bandwidth of the input spectrum, \sqrt{2 ln 2}·s is the FWHM diameter of each monochromatic beam, α is a proportionality constant and α·Δω is the linear displacement of the beam center at the offset frequency of Δω. Because it is assumed that the input beam profile is a superposition of many spatially transform-limited and temporally chirp-free beams, both Ω and s are then treated as real numbers in these calculations.

The focus is now on the calculation of Gaussian beam propagation for one particular monochromatic component exp [−(x−α·Δω)²/s²]. After passing through the objective, the output spatial profile is then modified to exp [−(x−α·Δω)²/s²]·exp(ikx²/2ƒ), where k is the wave vector, and ƒ is the focal length of the objective. Defining the position of the objective as z=0, under the paraxial approximation, the diffraction effect can be then modeled in the spatial frequency (kₓ) domain as the spatial dispersion exp (ikₓ²z/2k). After Fourier transforming exp [−(x−α·Δω)²/s²]·exp(ikx²/2ƒ) into the kₓ domain, multiplying the result by the spatial dispersion exp(ikₓ²·z/2k), and then inversely Fourier transforming the product back to real space, the diffracted spatial beam amplitude M(x,z,Δω) is calculated as

$$\begin{matrix}M ( x , z , Δ ω ) = \frac{s}{2 \sqrt{a \cdot ( 1 - i {ks}^{2} / 2 f )}} exp [ - \frac{{( x - b )}^{2}}{4 a} + i \cdot \frac{k \cdot α \cdot Δ ω}{f} x + c ] , \\ where & ( 3 ) \\ a = \frac{{f}_{1}^{2}}{{k}^{2} {s}^{2}} - i \cdot \frac{z - {f}_{1}^{2} / f}{2 k} , & ( 3 \text{-} 1 ) \\ b = α \cdot Δω \cdot ( 1 - \frac{z}{f} ) , & ( 3 \text{-} 2 ) \\ c = i \cdot \frac{k \cdot {α}^{2} {Δω}^{2}}{2 {f}^{2}} ( z - f ) , & ( 3 \text{-} 3 ) \\ {f}_{1}^{2} = {f}^{2} \cdot \frac{{k}^{2} {s}^{4}}{4 {f}^{2} + {k}^{2} {s}^{4}} . & ( 3 \text{-} 4 )\end{matrix}$$

The simultaneous temporal and spatial focused beam amplitude A₂ (x,z,t) is obtained by summing up the contributions over all Δω,

$$\begin{matrix}{A}_{2} ( x , z , t ) = {\int }_{- ∞}^{+ ∞} M ( x , z , Δω ) \cdot exp ( - \frac{{Δω}^{2}}{{Ω}^{2}} + iΔω t ) \cdot d Δω \approx \frac{s \cdot Ω}{2} \sqrt{\frac{π}{m \cdot a {\vert}_{k = {k}_{0}} \cdot ( 1 - i {k}_{0} {s}^{2} / 2 f )}} \cdot exp [ - \frac{{x}^{2}}{4 a {\vert}_{k = {k}_{0}}} - \frac{{( Ω \cdot t + n \cdot x )}^{2}}{4 m} ] , \\ where & ( 4 ) \\ m = 1 + \frac{{α}^{2} {Ω}^{2} \cdot {( z - f )}^{2}}{4 {f}^{2} \cdot a {\vert}_{k = {k}_{0}}} - i \cdot \frac{{k}_{0} \cdot {α}^{2} {Ω}^{2} \cdot ( z - f )}{2 {f}^{2}} , & ( 4 \text{-} 1 ) \\ n = \frac{{k}_{0} \cdot αΩ}{f} + i \cdot \frac{αΩ \cdot ( z - f )}{2 f \cdot a {\vert}_{k = {k}_{0}}} . & ( 4 \text{-} 2 )\end{matrix}$$

Note that in the derivation of Eq. (4), the dependence of the wave vector k=k₀+Δω/c on Δω is neglected, i.e., every k is replaced with k₀, which is the value corresponding to the center frequency of the input spectrum. This approximation is valid for the 100-fs pulses typically used in MPM because the spectral bandwidth of the pulse is a small fraction of the carrier frequency.

From Eq. (4), the FWHM pulse width τ is found to depend only on the ion distance z with no x dependence,

$$τ ( z ) = \frac{1}{\sqrt{Re [ 1 / m ]}} \cdot \frac{2 \sqrt{2 ln 2}}{Ω} . \qquad ( 5 )$$

Since the smallest value for m (i.e., m=1) is attainable only at the position z=ƒ, the pulse width will be the shortest at the focal point. Note that the FWHM pulse width of 2\sqrt{2 ln 2}/Ω the focal point is the transform-limited value for a Gaussian spectrum with a FWHM bandwidth \sqrt{2 ln 2}·Ω, indicating that the pulses at the focal point are once again chirp-free. At distances outside of the focal point, m becomes a large complex number. Thus, the temporal pulse width increases quickly and the pulses are highly chirped. Therefore, true simultaneous spatial and temporal focusing is obtained.

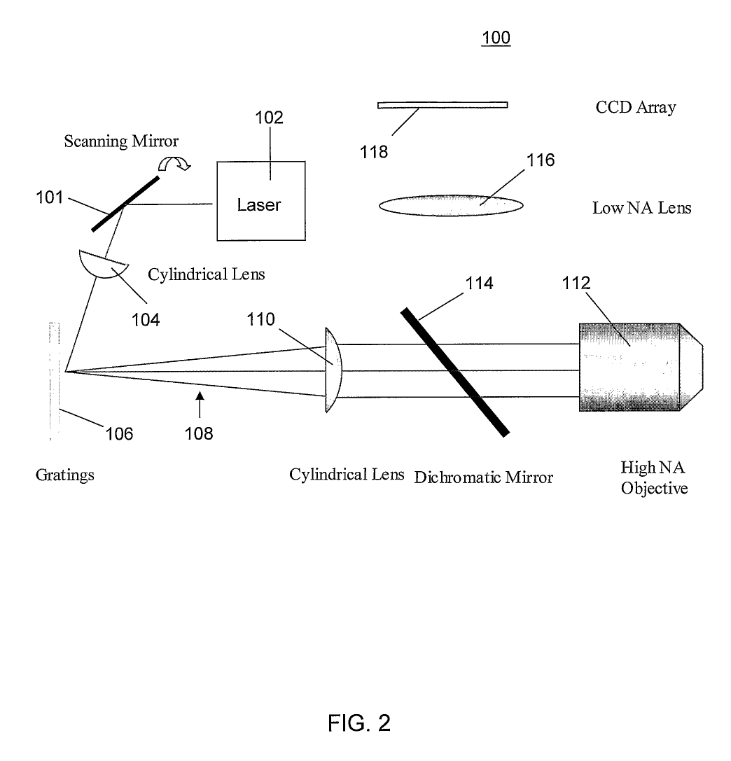

With reference now to FIG. 2, a system 100 is illustrated that is used to implement the invention in accordance with a preferred embodiment thereof. The system 100 includes a scanning mirror 101 for receiving a pulsed optical radiation beams from a laser 102 or other suitable pulsed optical source and directing the beam through first cylindrical lens 104 to a grating 106. The grating 106 separates the incident beam into a rainbow beam 108 including a plurality of separate beams, each of a different color or wavelength. The rainbow beam is then passed through another cylindrical lens 110, which collimates the beams thereby making them parallel and evenly spaced. The spaced beams are then incident on an objective lens 112, which then focuses the beams at a focal point as illustrated in FIG. 1. A dichromatic mirror 114 receives the detected fluorescence from a sample (not shown) at the focal point and directs it through a low NA lens 116 to a CCD array 118 or other suitable detector.

To demonstrate the simultaneous temporal and spatial focusing technique and support the intuitive picture as well as the theoretical analysis presented above, experimental work has also been carried out. Auto-correlation traces were measured using a setup similar to the system of FIG. 2. The experimental results confirmed the proposed concept of simultaneous spatial and temporal focusing.

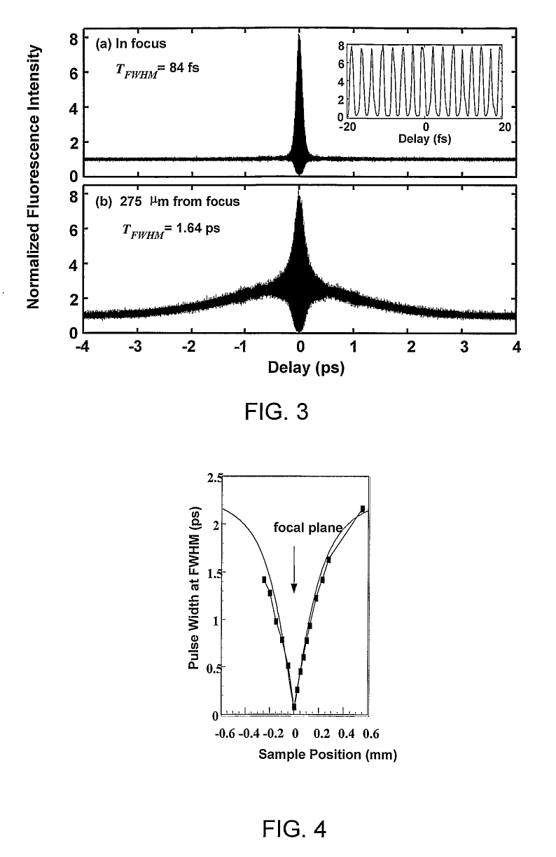

It should be noted that the geometric dispersion caused by the grating is automatically canceled after the process of recollimation and therefore the rainbow spectrum after the cylindrical lens is chirp-free. The simultaneous temporal and spatial focusing effect was then realized by passing the rainbow beam through an objective lens. In the experiment, because the separation between the objective and the cylindrical lens was adjusted to be the focal length of the cylindrical lens, the Gaussian beam profile for each monochromatic component was therefore spatially transform-limited at the back aperture of the objective lens. photon excited fluorescence of a thin Rhodamine sample as the nonlinear element. The autocorrelation traces at the focal plane and far away from the focus are shown respectively in FIGS. 3(a) and (b). At 275 μm away from the focus (FIG. 3(b)), a 1.64-ps pulse was measured and the characteristics of the interferometric autocorrelation trace were indicative of a highly chirped pulse. At the focal plane of the objective lens, however, a nearly chirp-free pulse was obtained and the measured 84-fs pulse width (FIG. 3(a)) is close to the original laser output. FIG. 4 shows the measured temporal pulse width (solid squares) at various distances away from the focal plane by translating the thin Rhodamine B sample. The measurements indicated that a value of 25 for the pulse width stretching factor (PWSF), which is defined as the ratio between the pulse width measured at the back aperture of the objective lens and the pulse width measured at the focal point, could be achieved using the current setup. Using the model described previously, a calculated curve for the pulse width (Eq. (5)) is also plotted in FIG. 4. The fitting parameter used in the theoretical plot are s=0.1 mm, α=1.44·10⁻¹³ mm/Hz, and ω=1.5·10¹³ Hz. From these numbers, the theoretical PWSF is calculated to be 21.6 which is slightly smaller than the measured one in order to get the best overall fitting. The difference between the calculated and measured data is believed to be caused by the fact that the theory is based on the Gaussian shape while the experiment is based on the Sech shape, therefore a pulse width scaling factor has to be used for corrections.

Because nonlinear excitation strongly depends on the excitation temporal pulse width, the temporal pulse width focusing shown in FIG. 4 can be used in multiphoton imaging to significantly reduce the out-of-focus background and improve the SBR performance. The most important parameter in determining the SBR improvement is PWSF. From Eq. (5), an analytical result for the PWSF is obtained as,

$$PWSF = \sqrt{1 + \frac{{α}^{2} {Ω}^{2}}{{s}^{2}}} \approx \frac{α \cdot Ω}{s} {\vert}_{α \cdot Ω >> s} . \qquad ( 6 )$$

Obviously, a larger PWSF leads to a better the SBR improvement. Since α·Ω is the size of the rainbow beam and s is the size of the monochromatic Gaussian beam (both measured at the back aperture of the objective), PWSF can be then intuitive understood as the beam expansion ratio due to the spatial separation of spectral components caused by the grating and cylindrical lens.

While such a reduction in background excitation will be valuable for multiphoton imaging applications in general, such as microscopy, endoscopy, spectroscopy, fluorescence, harmonic, etc., the demonstrated simultaneous spatial and temporal focusing is believed to be particularly beneficial for imaging deep into scattering biological tissues, where background excitation fundamentally limits the penetration depth of optical imaging.

When comparing the subject invention to the conventional line-focusing system, the reduction of the background noise is significant since outside the focus, both the enlarged beam size due to the lateral walkoff and the stretched pulse temporal width due to the geometry dispersion will contribute tremendously to decrease the unwanted multi-photon fluorescence backgrounds.

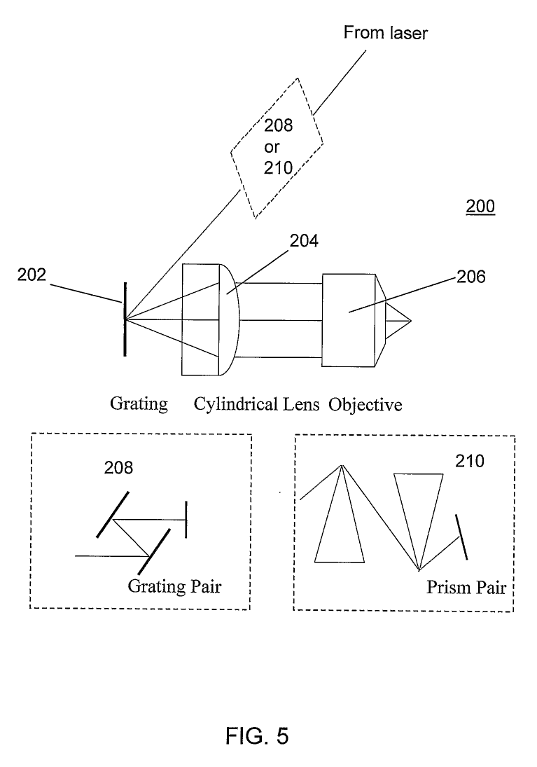

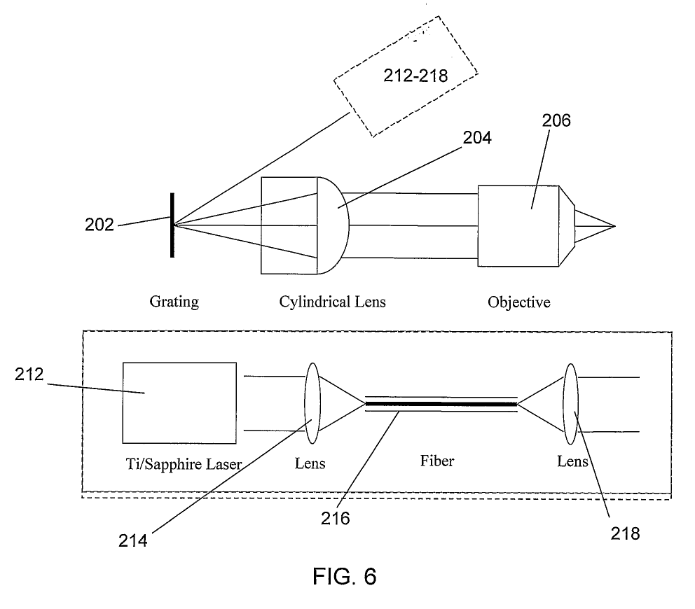

The present invention can also be employed to provide remote axial scanning of the maximum signal excitation plane for wide-field nonlinear microscopy. One practical concern in the design of nonlinear microscopy system is the ability to perform remote scanning. Other than traditional remote scanning technique, which are typically realized by adjusting the spatial wave-front profile, simultaneous spatial and temporal focusing technique when operated in the wide-field mode, provides another way to perform the axial scanning of the maximum signal excitation plane in the axial direction. Wide-field operation removes the spatial focusing and therefore inside the focal volume illumination field is only temporally focused. This temporal focusing is achieved because different colors are spatially separated, i.e. the effect of geometrical dispersion. The system 200 illustrated in FIG. 5 can be used to implement this concept. The system 200 includes a grating 202, cylindrical collimating lens 204 and an objective lens 206 as in the system 100 of FIG. 2, but also included a grating pair 208 or a prism pair 210. By adjusting the input spectrum chirp using the grating pair 208 or prism pair 210, the axial position of the maximum signal excitation plane shifts to the position where the input spectrum chirp is canceled by the geometrical dispersion, i.e. the position where the pulse temporal width is shortest. The formula that relates the input chirp and the shift of the maximum signal excitation plane can be obtained for Gaussian profiles. The results reads: Δz=z_{R}\sqrt{χ²−1}, where Δz is the axial shift of the maximum signal excitation plane, χ is the temporal pulse width broadening caused by the initial chirp, i.e. the pulse width ratio between the chirped case and the transform limited case, and z_{R} is the Raleigh length inside the focal volume corresponding to width of the mono-color component.

Another application of the present invention is for automatic dispersion compensation in wide-field nonlinear microscopy based on a single-core fiber. High-energy pulse delivery is one of the major concerns in the design of nonlinear microscopy system based on single-core fiber. It is usually limited by the dispersion accumulated through the propagation inside the fiber. FIG. 6 illustrates a modified version of the system 200 of FIG. 5 for implementing this application in which the output pulsed beam from a Ti/Sapphire laser 212 is passed through a lens into a single-core fiber 216, and then through another lens 218 to the grating 202.

When operating the simultaneous spatial and temporal focusing technique of the present invention in the wide-field mode, the fiber-delivery of ultrashort pulses is immune to the fiber chromatic dispersion. This is true because the simultaneous spatial and temporal focusing technique intrinsically inherits the geometrical dispersion into the system as a result of wavelength spatial separation. The fiber dispersion will be automatically compensated by shifting the temporal focal plane away from the geometrical optics one. Using the Gaussian profile, the maximum pulse temporal width broadening χ|ₘₐₓ that can be allowed without pre-dispersion compensation obeys the equation:

$$χ {\vert}_{max} \approx \sqrt{\frac{{z}_{M}}{{z}_{R}}} ,$$

where z_{R} is the Raleigh length inside the focal volume corresponding to width of the rainbow component. Note that

$$\sqrt{\frac{{z}_{M}}{{z}_{R}}}$$

is equivalent to the beam size stretching ratio at the objective back-aperture caused by the grating-lens pair. To give an example, if the size of the monocolor component is 0.1 mm, and the size of the rainbow is 2.5 mm, the stretching ratio is then 25, which means that one can tolerate dispersion up to 25 dispersion lengths. For silica fiber at 800 nm and the pulse spectrum is 10 nm, this corresponds to the fiber length of 1.5 m.

Although the invention has been disclosed in terms of a preferred embodiment and variations thereon, it will be understood that numerous additional modifications and variations could be made thereto without departing from the scope of the invention as defined in the following claims.

1. A method for multiphoton imaging comprising the steps of:
providing a beam of pulsed optical radiation;
separating said beam into a plurality of separate beams, each having a different wavelength from one another; and
recombining said plurality of beams at a focal point at a location where multiphoton imaging is desired.

2. The method of claim 1, wherein said separate beams are parallel to one another.

3. The method of claim 2, wherein said separate beams are formed by passing said beam of radiation through an optical grating and a collimating lens.

4. The method of claim, wherein said step of separating said beam comprises passing said beam through an optical grating.

5. The method of claim 1, further including the step of adjusting a spectrum chirp of said beam of pulsed optical radiation, thereby causing the location of said focal point to be scanned through an area to be imaged.

6. The method of claim 1, further including the step of passing said beam of pulsed radiation through a single core optical fiber without pre-dispersion compensation before separating said beam, whereby said separating and recombining steps automatically compensate for fiber induced dispersion.

7. A system for multiphoton imaging comprising:
a source of a beam of pulsed optical radiation;
a grating positioned to receive the beam of pulsed optical radiation from the source and separate the beam into a plurality of separate beams of different wavelength;
a first lens positioned to receive the plurality of separate beams and to convert them to separate collimated beams directed at an object to be imaged; and
a detector to detect fluorescence emitted by the object as a result of being contacted by the separate collimated beams.

8. The system of claim 7 further comprising:
an objective lens positioned to focus the separate collimated beams at a focal point on the object to be imaged.

9. The system of claim 7 further comprising:
a dichromatic mirror positioned to direct fluorescence emitted by the object to the detector.

10. The system of claim 9, wherein the dichromatic mirror is positioned to permit the separate collimated beams, traveling from the first lens to the object to be imaged, to pass through the dichromatic mirror.

11. The system of claim 7, wherein the detector is a CCD array.

12. The system of claim 7, wherein the source of a beam of pulsed optical radiation is a laser.

13. The system of claim 7 further comprising:
a single core optical fiber positioned to receive the beam before it reaches said grating.

14. The system of claim 7 further comprising:
a further lens to direct the beam of pulsed optical radiation to said grating.

15. The system of claim 14 further comprising:
a scanning mirror for receiving the beam of pulsed optical radiation and directing the beam to said further lens.

16. The system of claim 9 further comprising:
a low NA lens through which the fluorescence is directed to said detector.
